(19) United States
(12) Patent Application Publication
(10) Pub. No.: US 2017/0048375 A1
(43) Pub. Date: Feb. 16, 2017

(54) Patent for App, Function, Software, and/or Utility that utilize cell phones and its cameras for On-the-road, (driving) recording, home security recording, and phone protection and safety recording

(71) Applicants: Sangsik Kim, Warner Robins, GA (US); Minwoo Kim, Warner Robins, GA (US); Minsoo Kim, Warner Robins, GA (US)

(72) Inventors: Sangsik Kim, Warner Robins, GA (US); Minwoo Kim, Warner Robins, GA (US); Minsoo Kim, Warner Robins, GA (US)

(21) Appl. No.: 14/822,903

(22) Filed: Aug. 11, 2015

(51) Int. Cl. H04M 1/725

(52) U.S. Cl. CPC H04M 1/72525

(57) ABSTRACT

To include black box function into cell phones with an application, function, software widget, and utility that utilize cell phones which will provide continuous recording. The cell phones will utilize its front and rear camera to provide on-the-road recording that can be utilized for road accidents and vehicle theft-prevention, served as a security camera at home to monitor and record any suspicious or dangerous activities, and continuous recording which can be used to monitor and prevent any information leak from occurring to other users.

### TECHNICAL FIELD

This invention relates to an application, function, software and/or utility for continuous recording through cameras of cellular devices. More specifically, the invention will be used as a security cameras and black box.

### DESCRIPTION

Before the vehicle is in motion, the phone will be placed upon dashboard or mounted on a secured device. The cameras, front and back, on the phone will record videos while the vehicle is in motion. The camera will be continuously recording. The phone will record and save its driving history and this will be used in reports as evidence if accidents occur. The phone will also notify and alert the driver with an alarm if another vehicle and/or object become too close to the vehicle. Furthermore, this can also be used for theft-prevention due to its recording.

Second, this can be used as a security camera at home. By placing on a stand or mount on secure and safe location, the phone recording will monitor and/or record any suspicious activities in the house.

Third, with the continuous recording, the phone users can access and review the recording to see who has tried to unlock or touch the phone.

I claim:

1. A method to include black box function into cell phones.

2. The method of claim 1, the reasons and benefits to include black box function into cell phones:
a) cell phones with black box function will be mounted on the dashboard or on the windshield prior to driving, the cell phones' front and rear camera will provide continuous recording and will record driving histories and accidents.
b) cell phones with black box function will be utilized as home security by placing the cell phones on a safe location which once activated, the cell phones will continuously record and monitor any suspicious dangerous activity.
c) cell phones with black box function will provide continuous recording which can be used to monitor and prevent any information leak from occurring to other users.

3. The method of claim 1, wherein an app, software widget, and function will be placed into cell phones and the purpose is to have cell phones that will provide black box function.
